(19) United States
(12) Patent Application Publication
(10) Pub. No.: US 2022/0096315 A1
(43) Pub. Date: Mar. 31, 2022

(54) UNI-INNER STABILIZER CONFIGURATION FOR DERMA ROLLER APPARATUS

(71) Applicant: Hillary Hayman, Los Angeles, CA (US)

(72) Inventor: Hillary Hayman, Los Angeles, CA (US)

(21) Appl. No.: 17/079,071

(22) Filed: Oct. 23, 2020

(51) Int. Cl. A61H 15/00

(52) U.S. Cl. CPC A61H 15/0092; A61H 2201/1695; A61H 2015/0035

(57) ABSTRACT

A derma roller apparatus is provided. The derma roller apparatus has a handle, an inner stabilizer, and a head connected to the handle via the inner stabilizer. The head includes an axial member positioned transverse to the handle. Furthermore, the head includes a left cylindrical member positioned around the axial member to the left of the inner stabilizer, and a right cylindrical member positioned around the axial member to the right of the inner stabilizer. The head also includes a first plurality of needles situated around the left cylindrical member, and a second plurality of needles situated around the right cylindrical member.

### BACKGROUND

### 1. Field

This disclosure generally relates to skincare apparatuses for the skin around the eyes and face of a user. More particularly, the disclosure relates to a uni-inner stabilizer configuration for a derma roller apparatus.

### 2. General Background

The skin around the eyes and face are often viewed as an early indicator of aging. Accordingly, the quest for youthful skin around the eyes has spawned many skincare products and treatments over the course of many centuries; these products and treatments range from non-invasive (e.g., topical eye creams) all the way to extremely invasive (e.g., plastic surgery). Yet, the efficacy of a particular product and treatment is not necessarily correlated to an increased level of invasiveness. In fact, invasive procedures, such as plastic surgery or dermatological procedures, sometimes lead to significant disfigurations.

Various apparatuses have been developed for at-home use to promote skincare rejuvenation around the eyes and on the face, but many of these apparatuses also have questionable efficacy. Furthermore, some of these apparatuses are difficult for users to use, specifically with respect to accessing hard-to-reach areas around the eyes. Moreover, most users are a bit apprehensive about any type of treatment near the eyes.

### SUMMARY

In one embodiment, a derma roller apparatus is provided. The derma roller apparatus has a handle, an inner stabilizer, and a head connected to the handle via the inner stabilizer.

The head includes an axial member positioned transverse to the handle. Furthermore, the head includes a left cylindrical member positioned around the axial member to the left of the inner stabilizer, and a right cylindrical member positioned around the axial member to the right of the inner stabilizer. The head also includes a first plurality of needles situated around the left cylindrical member, and a second plurality of needles situated around the right cylindrical member.

In another embodiment, the derma roller apparatus may have a left head and a right head, which are each connected to the handle via the inner stabilizer. The left head may have a left axial member positioned transverse to the handle, a left cylindrical member positioned around the left axial member to the left of the inner stabilizer, and a first plurality of needles situated around the left cylindrical member. Conversely, the right head may have a right axial member positioned transverse to the handle, a right cylindrical member positioned around the right axial member to the right of the inner stabilizer, and a second plurality of needles situated around the right cylindrical member.

In yet another embodiment, the derma roller apparatus may have a single axial member around which both the left cylindrical member of the left head and right cylindrical member of the right head are positioned.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1A illustrates a top perspective view of a derma roller apparatus.

FIG. 1B illustrates a front orthographic view of derma roller apparatus in which the relative thickness of the outer stabilizers is apparent.

FIG. 2 illustrates a user utilizing the prior configuration derma roller apparatus illustrated in FIGS. 1A and 1B.

FIG. 3A illustrates a top perspective view of the uni-inner stabilizer configuration for the derma roller.

FIG. 3B illustrates a rear, side perspective view of the uni-inner stabilizer configuration for the derma roller illustrated in FIG. 3A.

FIG. 3C illustrates a top perspective view of the uni-inner stabilizer configuration for the derma roller illustrated in FIG. 3A.

FIG. 3D illustrates a disassembly view of the derma roller illustrated in FIG. 3A.

FIG. 4 illustrates the user utilizing the derma roller apparatus 100 illustrated in FIG. 3.

FIG. 5A illustrates a swivel that is utilized to move the head with respect to the handle along a pitch axis in an upward motion.

FIG. 5B illustrates the swivel of FIG. 5A in a neutral position.

FIG. 5C illustrates the swivel that is utilized to move the head with respect to the handle along a pitch axis in a downward motion.

FIG. 6A illustrates a swivel that is utilized to move the head with respect to the handle along a yaw axis in a rightward motion.

FIG. 6B illustrates the swivel of FIG. 6A in a neutral position.

FIG. 6C illustrates the swivel that is utilized to move the head with respect to the handle 101 along a pitch axis in a downward motion.

FIG. 7A illustrates a swivel that is utilized to move the head with respect to the handle 505 along a roll axis in a rightward motion.

FIG. 7B illustrates the swivel of FIG. 7A in a neutral position.

FIG. 7C illustrates the swivel that is utilized to move the head with respect to the handle along a roll axis in a leftward motion.

FIG. 8 illustrates the user utilize the derma roller apparatus, illustrated in FIG. 6, to access an edge of the nose to derma roll over crow's feet.

FIG. 9 illustrates the user utilizing the derma roller apparatus to access an edge of the nose to derma roll over a laugh line.

### DETAILED DESCRIPTION

A uni-inner stabilizer configuration for a derma roller apparatus is provided to allow users to perform skincare rejuvenation in areas of skin covering and surrounding the eyes. In contrast with previous derma roller apparatuses, which prevented access to hard-to-reach areas around the eyes, the uni-inner stabilizer configuration for the derma roller provides improved access to those areas. As a result, the uni-inner stabilizer configuration for a derma roller allows for improved collagen production in the eye area of a user, thereby providing the potential for improved skincare rejuvenation to help reduce or eliminate eye skin conditions such as crow's feet, dark circles, etc. The uni-inner stabilizer configuration is specifically configured to the exclusion of outer stabilizers. Furthermore, the uni-inner stabilizer configuration is restricted to one inner stabilizer.

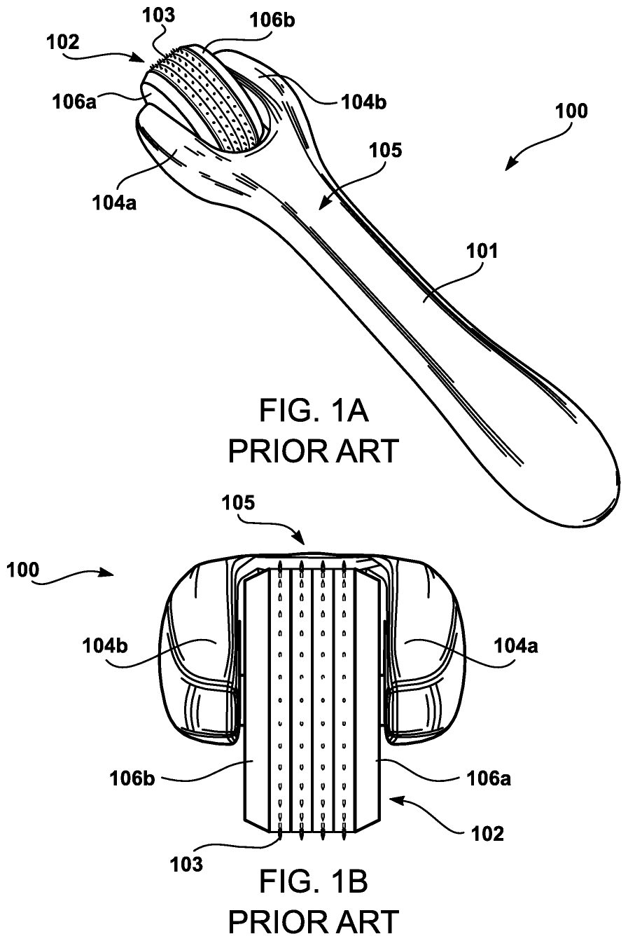

For purposes of comparison, FIGS. 1A and 1B are provided to illustrate an example of a prior configuration. In particular, FIG. 1A illustrates a top perspective view of a derma roller apparatus 100. A handle 101 is connected to a derma roller head 102, which has a plurality of needles 103 situated around the circumference thereof. In one embodiment, the derma roller head 102 may be formed in the shape of a cylinder.

A pair of outer stabilizers 104a and 104b are utilized to connect the handle 101 to the derma roller head 102. In particular, each of the outer stabilizers 104a and 104b extends from a top portion 105 of the handle 101 toward a first end 106a and a second end 106b of the derma roller head 102, respectively. In essence, the outer stabilizers 104a and 104b stabilize the derma roller head 102 during motion of the handle 101 such that the plurality of needles 103 rotate around the axis transverse to the handle 101 with minimal movement along any other axis. To provide for the foregoing stabilization, many prior configurations, such as the derma roller apparatus 100, have relatively thick members (e.g., each ranging from approximately one sixth inches to one quarter inches). However, as shall be illustrated, the thickness of these outer stabilizers 104a and 104b interferes with accessing the hard-to-reach areas around the eyes of a user. FIG. 1B illustrates a front orthographic view of derma roller apparatus 100 in which the relative thickness of the outer stabilizers 104a and 104b is apparent.

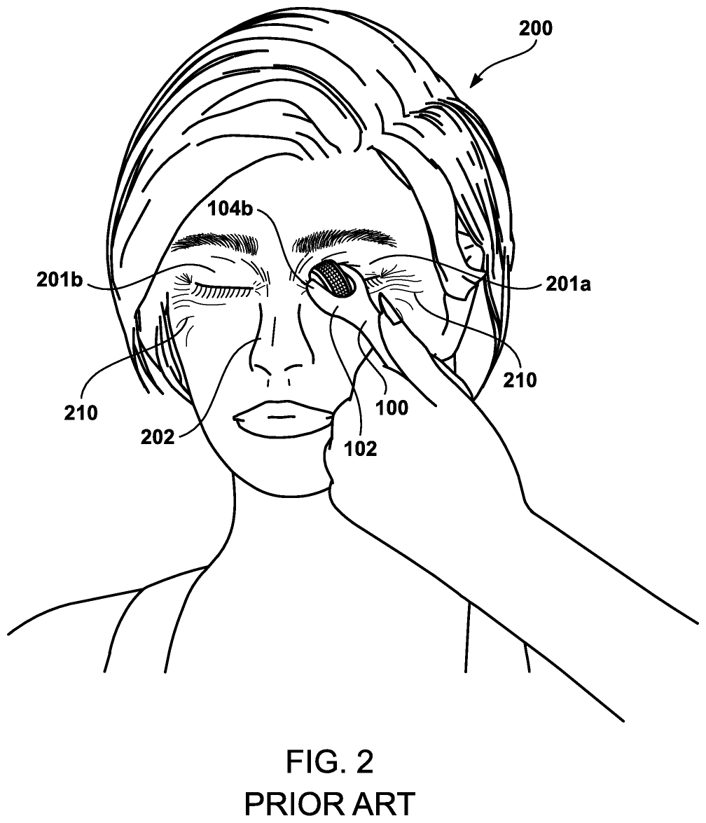

FIG. 2 illustrates a user 200 utilizing the prior configuration derma roller apparatus 100 illustrated in FIGS. 1A and 1B. In order to help reduce crow's feet, as an example, the user 200 performs movement of the derma roller apparatus 100 around skin of her eyes 201a and 201b. In particular, the user 200 is attempting to roll the derma roller head 102 in the corner of the area of the eye 201a; this particular corner abuts an edge of the nose 202 of the user 200. However, as illustrated, the user 200 has difficulty positioning the derma roller head 102 in that corner, as a result of the left outer stabilizer 104b essentially blocking the plurality of needles 103 from accessing the skin in that corner. As a result, all of the skin around the eyes 201a and 201b of the user 200 do not receive optimal needle penetration for skincare rejuvenation.

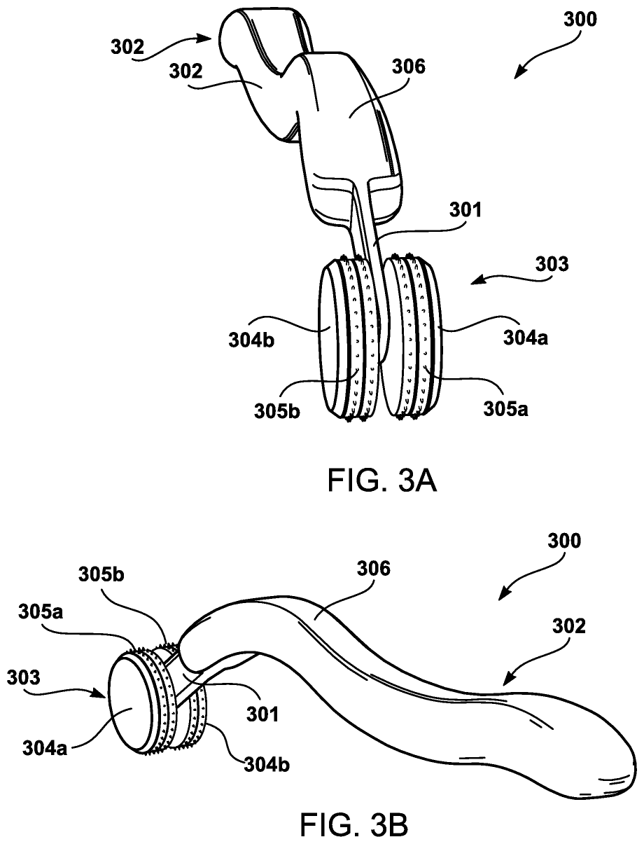

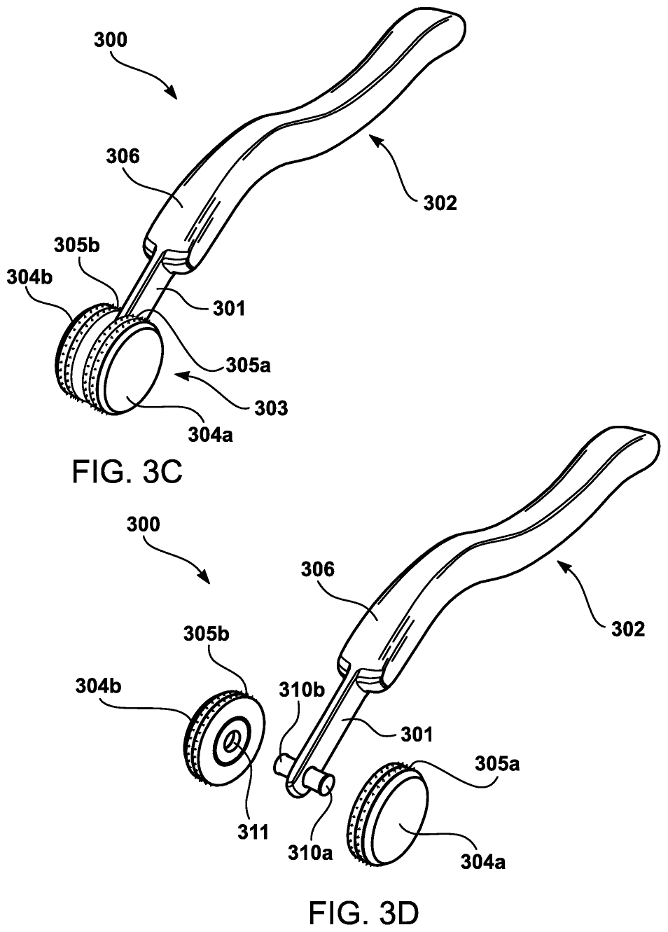

By way of contrast, FIGS. 3A-3D illustrate a uni-inner stabilizer configuration for a derma roller 300 that has a single inner stabilizer 301, as opposed to the outer stabilizers 104a and 104b of the prior configuration derma roller apparatus 100 illustrated in FIGS. 1A and 1B. FIG. 3A illustrates a top perspective view of the uni-inner stabilizer configuration for the derma roller 300. A handle 302 is connected to the inner stabilizer 301, which is connected to a derma roller head 303. In one embodiment, the derma roller head 303 has a left cylindrical member 304a and a right cylindrical member 304b upon which a first plurality of needles 305a and a second plurality of needles 305b are situated, respectively.

The inner stabilizer 301 extends from a top portion 306 of the handle 302 toward the derma roller head 303. In one embodiment, the inner stabilizer 301 extends toward, and is connected to, an axial member situated in between the right cylindrical member 304a and the left cylindrical member 304b. Furthermore, in one embodiment, the inner stabilizer 301 performs stabilization of the derma roller head 303 to the exclusion an outer stabilizer. Accordingly, the uni-inner stabilizer configuration for a derma roller 300 is able to provide access to the hard-to-reach areas of the skin surrounding the eyes of a user, without the obstruction of outer stabilizers of the previous configurations.

Furthermore, the uni-inner stabilizer configuration for the derma roller 300 may be optimized for convenient access to the skin around the eyes of the user. For instance, the width of the derma roller head 300 may be optimized to be in a range of approximately one half inch to one inch. (The range provided for herein is an example of a range—slight variations (e.g., within zero to twenty percent) may be utilized instead.) For instance, each of the cylindrical members 304a and 304b may have a width of approximately one quarter of an inch, and the inner stabilizer 301 may have a width of approximately one tenth of an inch. (The width of the inner stabilizer 301 is only provided as an example.)

FIG. 3B illustrates a rear, side perspective view of the uni-inner stabilizer configuration for the derma roller 300 illustrated in FIG. 3A. Furthermore, FIG. 3C illustrates a top perspective view of the uni-inner stabilizer configuration for the derma roller 300 illustrated in FIG. 3A. Finally, FIG. 3D illustrates a disassembly view of the derma roller 300 illustrated in FIG. 3A. One or more axial members 310a and 310b may be adhered to the inner stabilizer 301. Furthermore, a right cylindrical member 304a (e.g., one or more cylindrical discs) may be positioned on the axial member 310a, and a left cylindrical member 304b (e.g., one or more cylindrical discs) may be positioned on the axial member 310b. As an example, a bearing 311 may receive the axial member 310a and 310b. (Although different axial members 310a and 310b are illustrated for each cylindrical member 305a and 305b, one axial member may be utilized instead.)

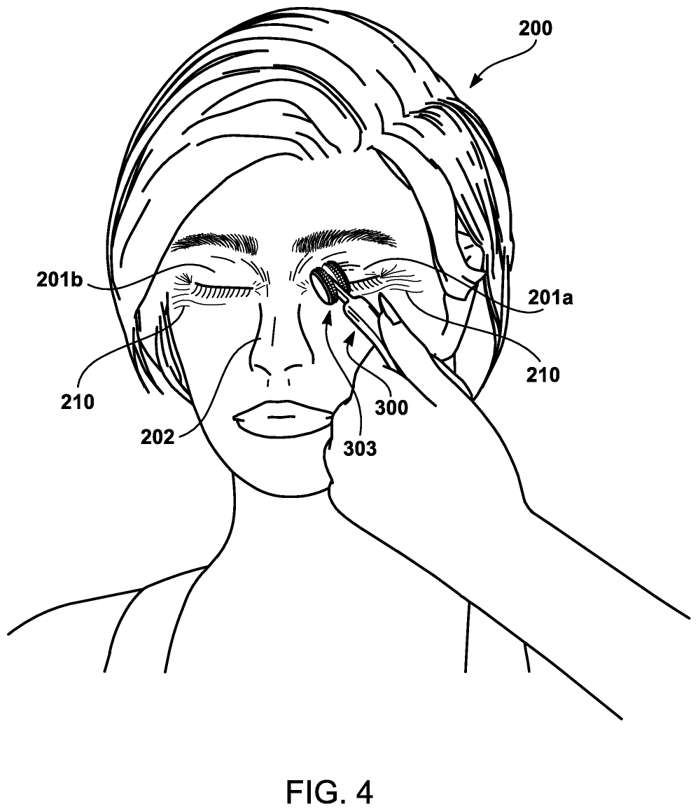

FIG. 4 illustrates the user 200 utilizing the derma roller apparatus 100 illustrated in FIG. 3. In particular, the user 200 is able to utilize the derma roller apparatus 100 as an eye derma roller. For example the user 200 may move the derma roller apparatus 100 with respect to crow's feet 210 by an edge of the nose 202. The user 300 is able to adjust the angle of the head 303 to access the hard-to-reach edge by the nose 202, which could be quite difficult if a thick outer stabilizer were present. The user 200 may also utilize the derma roller apparatus 100 over the eyelids 201a and 201b.

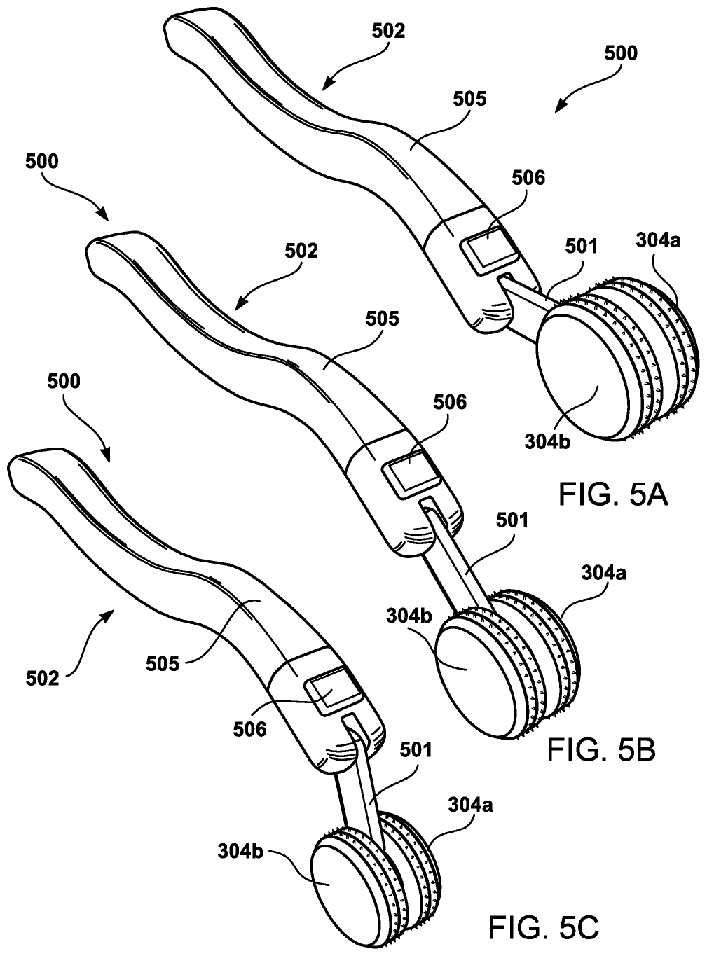

Although the previous embodiments were illustrated as having the handle 302 fixed with respect to the head 302 and the inner stabilizer 500, in an alternative embodiment illustrated in FIGS. 5A-5C, a swivel may be configured to effectuate movement of a handle 505 with respect to a head 303. In particular, FIG. 5A illustrates a swivel that is utilized to move the head 303 with respect to the handle 302 along a pitch axis in an upward motion. In one embodiment, the inner stabilizer 500 is connected to the head 303 and also the swivel. Further, in one embodiment, an actuator 506 (e.g., button) may be utilized to lock the head 303 into a particular position. For example, the actuator 506 may be positioned on the handle 505, and may allow the head 303 to be locked into a particular angular position with respect to the handle 502, thereby allowing the user 200 to have the convenience of adjusting the head 303 to a particular angle for enhanced access to hard-to-reach areas. FIG. 5B illustrates the swivel of FIG. 5A in a neutral position. Finally, FIG. 5C illustrates the swivel 805 that is utilized to move the head 802 with respect to the handle 101 along a pitch axis in a downward motion.

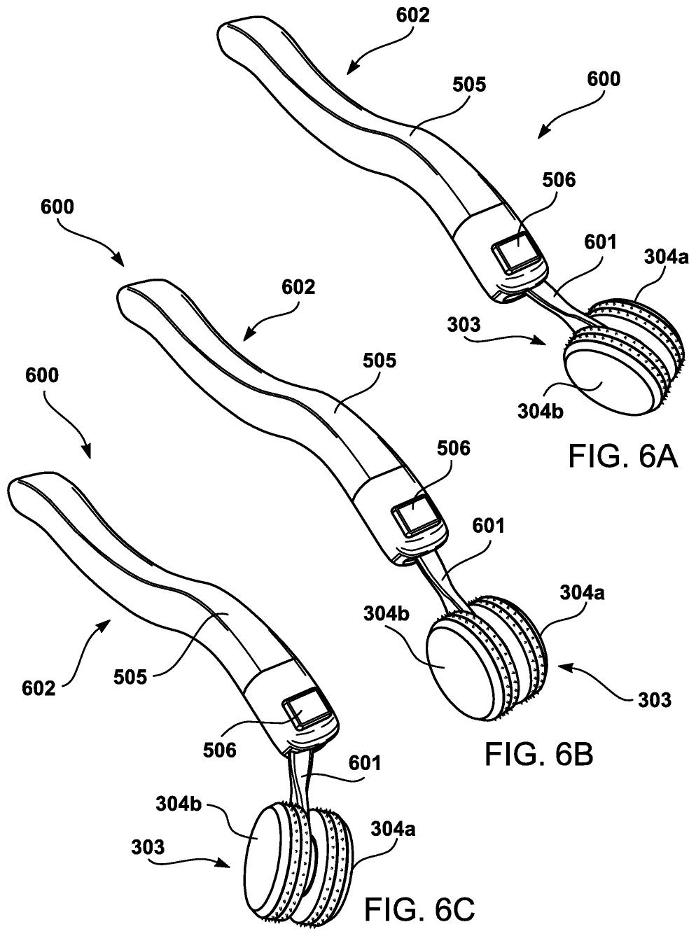

FIGS. 6A-6C illustrate a swivel that is configured to effectuate movement of the handle 101 with respect to the head 303 along a yaw axis. In particular, FIG. 6A illustrates a swivel that is utilized to move the head 303 with respect to the handle 505 along a yaw axis in a rightward motion. FIG. 6B illustrates the swivel of FIG. 6A in a neutral position. Finally, FIG. 6C illustrates the swivel that is utilized to move the head 303 with respect to the handle 101 along a pitch axis in a downward motion.

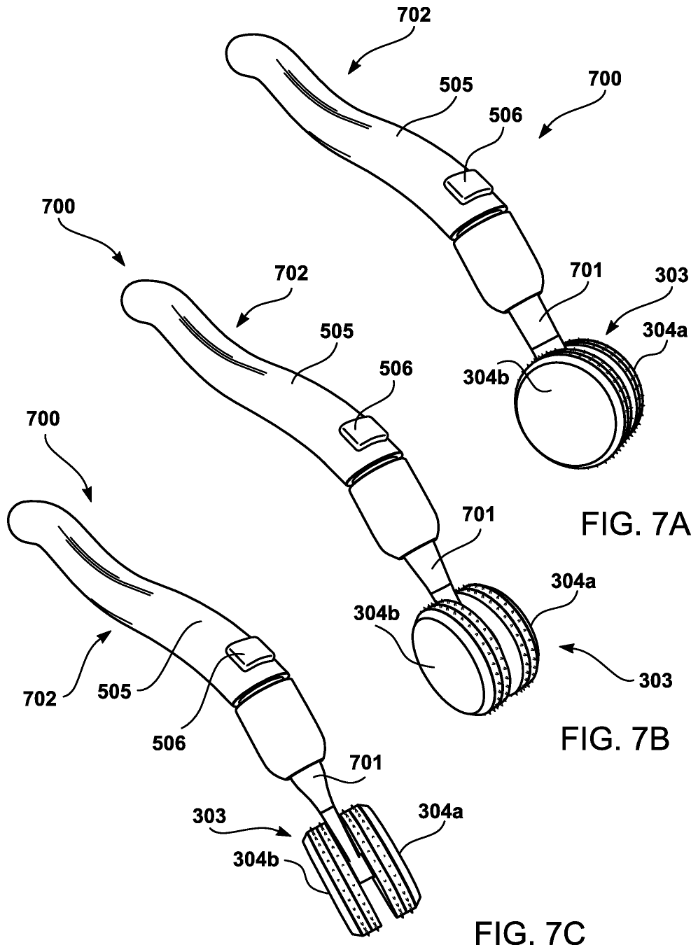

Moreover, FIGS. 7A-7C illustrate a swivel 701 that is configured to effectuate movement of the handle 101 with respect to the head 303 along a roll axis. In particular, FIG. 7A illustrates a swivel that is utilized to move the head 303 with respect to the handle 505 along a roll axis in a rightward motion via an inner stabilizer 701. FIG. 7B illustrates the swivel of FIG. 7A in a neutral position. Finally, FIG. 7C illustrates the 701 that is utilized to move the head 303 with respect to the handle 505 along a roll axis in a leftward motion.

The handle 101 may be fixed. Alternatively, the handle 101 may be telescopic.

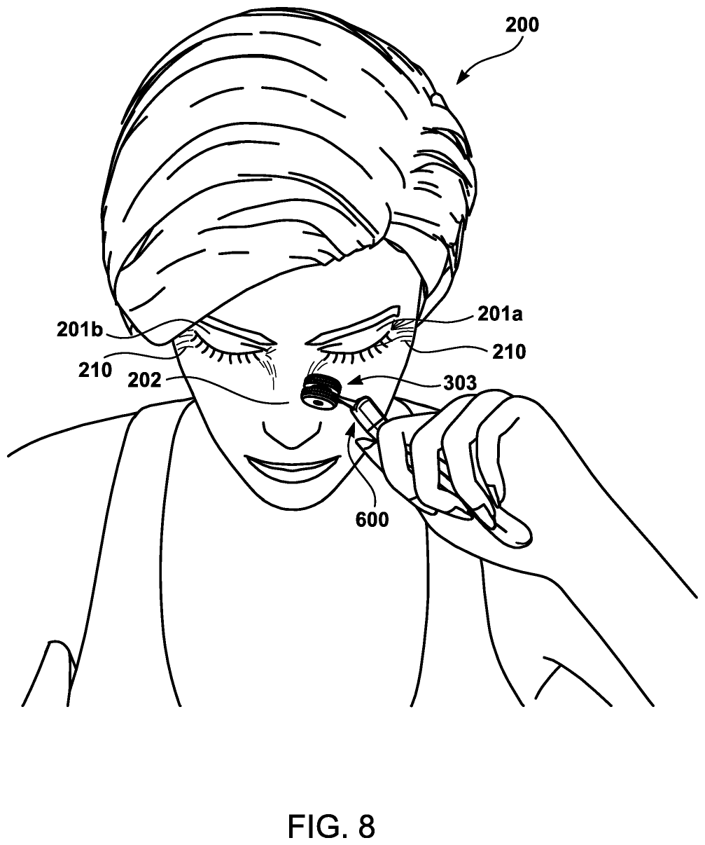

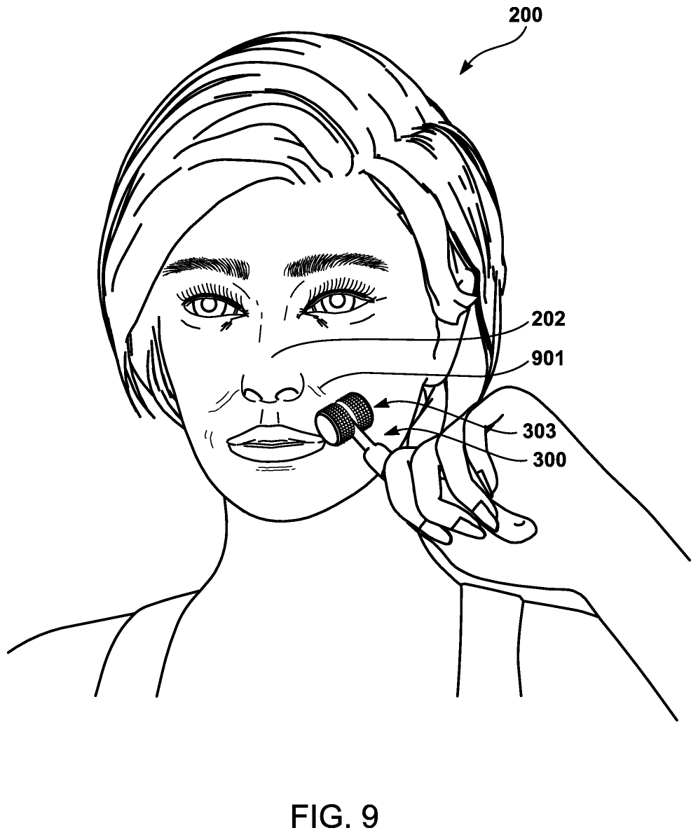

FIG. 8 illustrates the user 200 utilize the derma roller apparatus 600, illustrated in FIG. 6, to access an edge of the nose 202 to derma roll over crow's feet 210. The user 200 is able to adjust the angle of the head 303 to accommodate the crevice by the edge of the nose 202. In one embodiment, the user 200 may lock the angle. Although the derma roller apparatus 600 is illustrated as an example, other derma roller apparatuses provided for herein may be utilized instead. As another example, FIG. 9 illustrates the user 200 utilizing the derma roller apparatus 300 to access an edge of the nose 202 to derma roll over a laugh line 901.

It is understood that the apparatuses described herein may also be applied in other types of apparatuses. Those skilled in the art will appreciate that the various adaptations and modifications of the embodiments of the apparatuses described herein may be configured without departing from the scope and spirit of the present processes and systems. Therefore, it is to be understood that, within the scope of the appended claims, the present apparatuses may be practiced other than as specifically described herein.

I claim:

1. A derma roller apparatus comprising:
a handle;
a single inner stabilizer; and
a head connected to the handle via the inner stabilizer, the head comprising:
an axial member positioned transverse to the handle,
a left cylindrical member positioned around the axial member to the left of the inner stabilizer,
a first plurality of needles situated around the left cylindrical member,
a right cylindrical member positioned around the axial member to the right of the inner stabilizer,
a second plurality of needles situated around the right cylindrical member.

2. The derma roller apparatus of claim 1, wherein the axial member has a width in a range of one quarter inch to one half inch.

3. The derma roller apparatus of claim 1, wherein the first plurality of needles is equal in quantity to the second plurality of needles.

4. The derma roller apparatus of claim 1, wherein the inner stabilizer stabilizes the head during movement of the derma roller apparatus without one or more outer stabilizers.

5. The derma roller apparatus of claim 1, wherein the handle is fixed with respect to the head via the inner stabilizer.

6. The derma roller apparatus of claim 1, wherein the inner stabilizer comprises a swivel, the handle being configured to move with respect to the head via the swivel.

7. The derma roller apparatus of claim 6, wherein the inner stabilizer comprises one or more stoppers that restrict movement of the handle within a predetermined angular range.

8. The derma roller apparatus of claim 1, wherein the handle is telescopic.

9. The derma roller apparatus of claim 1, wherein each of the plurality of first needles has a length of at least five tenths millimeters.

10. The derma roller apparatus of claim 1, wherein each of the plurality of second needles has a length of at least five tenths millimeters.

11. A derma roller apparatus comprising:
a handle;
an inner stabilizer;
a left head connected to the handle via the inner stabilizer, the left head comprising:
a left axial member positioned transverse to the handle,
a left cylindrical member positioned around the left axial member to the left of the inner stabilizer,
a first plurality of needles situated around the left cylindrical member; and
a right head connected to the handle via the inner stabilizer, the right head comprising:
a right axial member positioned transverse to the handle,
a right cylindrical member positioned around the right axial member to the right of the inner stabilizer, and
a second plurality of needles situated around the right cylindrical member.

12. The derma roller apparatus of claim 11, wherein the left axial member and the right axial member have a width in a range of one quarter inch to one half inch.

13. The derma roller apparatus of claim 11, wherein the first plurality of needles is equal in quantity to the second plurality of needles.

14. The derma roller apparatus of claim 11, wherein the inner stabilizer stabilizes the head during movement of the derma roller apparatus without one or more outer stabilizers.

15. The derma roller apparatus of claim 11, wherein the handle is fixed with respect to the head via the inner stabilizer.

16. The derma roller apparatus of claim 1, wherein the inner stabilizer comprises a swivel, the handle being configured to move with respect to the head via the swivel.

17. The derma roller apparatus of claim 16, wherein the inner stabilizer comprises one or more stoppers that restrict movement of the handle within a predetermined angular range.

18. The derma roller apparatus of claim 11, wherein the handle is telescopic.

19. A derma roller apparatus comprising:
a handle;
an inner stabilizer;
an axial member positioned transverse to the handle;
a left head connected to the handle via the inner stabilizer, the left head comprising:
a left cylindrical member positioned around the axial member to the left of the inner stabilizer,
a first plurality of needles situated around the left cylindrical member; and
a right head connected to the handle via the inner stabilizer, the right head comprising:
a right cylindrical member positioned around the axial member to the right of the inner stabilizer, and
a second plurality of needles situated around the right cylindrical member.

20. The derma roller apparatus of claim 19, wherein the axial member has a width in a range of one quarter inch to one half inch.
